(19) United States
(12) Patent Application Publication
(10) Pub. No.: US 2025/0317967 A1
(43) Pub. Date: Oct. 9, 2025

(54) METHOD AND APPARATUS FOR RESOURCE POOL CONFIGURATION OVER UNLICENSED SPECTRUM

(71) Applicant: Lenovo (Beijing) Limited, Beijing (CN)

(72) Inventors: Xiaodong Yu, Beijing (CN); Haipeng Lei, Beijing (CN); Zhennian Sun, Beijing (CN); Yu Zhang, Beijing (CN); Xin Guo, Beijing (CN)

(73) Assignee: Lenovo (Beijing) Limited, Beijing (CN)

(21) Appl. No.: 18/860,538

(22) PCT Filed: Apr. 28, 2022
(86) PCT No.: PCT/CN2022/089953

§ 371 Date: Oct. 25, 2024

(51) Int. Cl. H04W 74/0816; H04W 74/08; H04W 92/18

(52) U.S. Cl. CPC H04W 74/0816; H04W 74/0875; H04W 92/18

(57) ABSTRACT

Embodiments of the present disclosure relate to methods and apparatuses for a resource pool configuration over an unlicensed spectrum. According to some embodiments of the disclosure, a user equipment (UE) may include a transceiver; and a processor coupled to the transceiver. The processor may be configured: to receive configuration information for initiating a channel occupancy time (COT) via the transceiver from a network, wherein the configuration information is associated with at least one of: a channel access priority class (CAPC), or an energy detection operation related to the COT; and to communicate with a further UE via the transceiver over a sidelink.

### TECHNICAL FIELD

Embodiments of the present disclosure generally relate to wireless communication technology, and more particularly to a resource pool configuration over an unlicensed spectrum.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In the above wireless communication systems, a user equipment (UE) may communicate with another UE via a data path supported by an operator's network, e.g., a cellular or a Wi-Fi network infrastructure. The data path supported by the operator's network may include a base station (BS) and multiple gateways.

Some wireless communication systems may support sidelink communications, in which devices (e.g., UEs) that are relatively close to each other may communicate with one another directly via a sidelink, rather than being linked through the BS. The term “sidelink” may refer to a radio link established for communicating among devices (e.g., UEs), as opposed to communicating via the cellular infrastructure (e.g., uplink and downlink). Sidelink transmission may be performed on a licensed spectrum and an unlicensed spectrum.

There is a need for handling a resource pool configuration over an unlicensed spectrum.

### SUMMARY

Some embodiments of the present disclosure provide a user equipment (UE). The UE may include: a transceiver; and a processor coupled to the transceiver. The processor may be configured: to receive configuration information for initiating a channel occupancy time (COT) via the transceiver from a network, wherein the configuration information is associated with at least one of: a channel access priority class (CAPC), or an energy detection operation related to the COT; and to communicate with a second UE via the transceiver over a sidelink.

In some embodiments, the configuration information is configured or preconfigured to the UE.

In some embodiments, in response to the configuration information being associated with the CAPC, the configuration information includes at least one of: a first CAPC value for a resource pool on an unlicensed band; a first mapping relationship between one or more traffic priority level values and one or more CAPC values; a priority level value for the resource pool on the unlicensed band; or a second mapping relationship between the priority level value and one CAPC value.

In some embodiments, the processor of the UE is configured: to determine the first CAPC value based on the configuration information; and to perform a channel access procedure for initiating the COT based on one or more parameters related to the first CAPC value.

In some embodiments, the processor of the UE is configured: to determine a traffic priority level value of the UE; and to determine a second CAPC value corresponding to the traffic priority level value based on the first mapping relationship.

In some embodiments, the processor of the UE is configured: to determine the first CAPC value based on the configuration information; to determine a greater CAPC value between the first CAPC value and the second CAPC value; and to perform a channel access procedure for initiating the COT based on one or more parameters related to the greater CAPC value.

In some embodiments, the processor of the UE is configured: to determine the priority level value based on the configuration information; to determine a traffic priority level value of the UE; and to transmit the traffic of the UE via the transceiver to the second UE over the sidelink, in response to the traffic priority level value being less than or equal to the priority level value; or to not transmit the traffic of the UE to the second UE, in response to the traffic priority level value being greater than the priority level value.

In some embodiments, to transmit the traffic of the UE, the processor of the UE is configured: to determine the one CAPC value based on the second mapping relationship; and to perform a channel access procedure for initiating the COT based on one or more parameters related to the one CAPC value.

In some embodiments, in response to the configuration information being associated with the energy detection operation, the configuration information includes a first energy detection threshold for a resource pool on an unlicensed band.

In some embodiments, the processor of the UE is configured: to set a second energy detection threshold to be equal to or less than the first energy detection threshold.

In some embodiments, the processor of the UE is configured: to perform a listen-before-talk (LBT) type 2 procedure based on the second energy detection threshold; and to use the COT initiated by the second UE during communicating with the second UE.

In some embodiments, the processor of the UE is configured to perform a channel access procedure for initiating the COT based on the second energy detection threshold.

In some embodiments, the channel access procedure is a listen-before-talk (LBT) type 1 procedure.

In some embodiments, the processor of the UE is configured to receive data via the transceiver from the second UE over the sidelink using the COT initiated by the UE.

Some embodiments of the present disclosure provide a user equipment (UE). The UE may include: a transceiver; and a processor coupled to the transceiver. The processor may be configured: to determine at least one of a first channel access priority class (CAPC) value or a first priority level value of a first traffic of the UE; to receive at least one of a second CAPC value or a second priority level value of a second traffic of a second UE via the transceiver from the second UE over a sidelink; and to determine a greater CAPC value between the first CAPC value and the second CAPC value, or to determine a greater priority level value between the first priority level value and the second priority level value.

In some embodiments, the processor of the UE is configured to transmit at least one of the greater CAPC value or the greater priority level value via the transceiver to the second UE over the sidelink.

In some embodiments, the processor of the UE is configured to perform a channel access procedure for initiating a channel occupancy time (COT) based on at least one of the greater CAPC value or the greater priority level value.

In some embodiments, the channel access procedure is a listen-before-talk (LBT) type 1 procedure.

In some embodiments, the processor of the UE is configured to receive data via the transceiver from the second UE over the sidelink using the COT initiated by the UE.

In some embodiments, the processor of the UE is configured to transmit an energy detection threshold of the UE via the transceiver to the second UE over the sidelink, and wherein a listen-before-talk (LBT) type 2 procedure is performed by the second UE based on the energy detection threshold.

Some embodiments of the present disclosure provide a user equipment (UE). The UE may include: a transceiver; and a processor coupled to the transceiver. The processor may be configured: to transmit at least one of a first CAPC value or a first priority level value of a first traffic of the UE via the transceiver to a second UE over a sidelink; and to receive at least one of a greater CAPC value or a greater priority level value via the transceiver from the second UE over the sidelink, wherein the greater CAPC value is determined by the second UE between the first CAPC value and a second CAPC value of a second traffic of the second UE, and wherein the greater priority level value is determined by the second UE between the first priority level value and a second priority level value of the second traffic of the second UE.

In some embodiments, the processor of the UE is configured: to receive an energy detection threshold via the transceiver from the second UE over the sidelink; and to perform a listen-before-talk (LBT) type 2 procedure based on the energy detection threshold.

In some embodiments, the processor of the UE is configured: to determine whether the second UE is a destination UE of the UE; and in response to determining that the second UE is a destination UE of the UE, to use a channel occupancy time (COT) initiated by the second UE.

In some embodiments, the processor of the UE is configured: to determine whether the UE will perform a broadcast transmission or a groupcast transmission with a feedback of only negative acknowledgement (NACK); and in response to determining that the UE will perform the broadcast transmission or the groupcast transmission with the feedback of only NACK, to use a channel occupancy time (COT) initiated by the second UE.

In some embodiments, the processor of the UE is configured: to transmit data via the transceiver to the second UE over the sidelink using the COT initiated by the second UE.

Some embodiments of the present application also provide a network node (e.g., a base station (BS)). The network node includes a transceiver; and a processor coupled to the transceiver. The processor may be configured to transmit configuration information for initiating a channel occupancy time (COT) via the transceiver to a user equipment (UE), wherein the configuration information is associated with at least one of: a channel access priority class (CAPC), or an energy detection operation related to the COT.

In some embodiments, the configuration information is configured or preconfigured to the UE.

In some embodiments, in response to the configuration information being associated with the CAPC, the configuration information includes at least one of: a CAPC value for a resource pool on an unlicensed band; a first mapping relationship between one or more traffic priority level values and one or more CAPC values; a priority level value for the resource pool on the unlicensed band; or a second mapping relationship between the priority level value and one CAPC value.

In some embodiments, in response to the configuration information being associated with the energy detection operation, the configuration information includes an energy detection threshold for a resource pool on an unlicensed band.

Some embodiments of the present disclosure provide a method for wireless communication performed by a user equipment (UE). The method may include: receiving configuration information for initiating a channel occupancy time (COT) from a network, wherein the configuration information is associated with at least one of: a channel access priority class (CAPC), or an energy detection operation related to the COT; and communicating with a second UE over a sidelink.

Some embodiments of the present disclosure provide a method for wireless communication performed by a user equipment (UE). The method may include: determining at least one of a first channel access priority class (CAPC) value or a first priority level value of a first traffic of the UE; receiving at least one of a second CAPC value or a second priority level value of a second traffic of a second UE from the second UE over a sidelink; and determining a greater CAPC value between the first CAPC value and the second CAPC value, or determining a greater priority level value between the first priority level value and the second priority level value.

Some embodiments of the present disclosure provide a method for wireless communication performed by a user equipment (UE). The method may include: transmitting at least one of a first CAPC value or a first priority level value of a first traffic of the UE to a second UE over a sidelink; and receiving at least one of a greater CAPC value or a greater priority level value from the second UE over the sidelink, wherein the greater CAPC value is determined by the second UE between the first CAPC value and a second CAPC value of a second traffic of the second UE, and wherein the greater priority level value is determined by the second UE between the first priority level value and a second priority level value of the second traffic of the second UE.

Some embodiments of the present disclosure provide a method for wireless communication performed by a network node (e.g., a BS). The method may include transmitting configuration information for initiating a channel occupancy time (COT) to a user equipment (UE), wherein the configuration information is associated with at least one of: a channel access priority class (CAPC), or an energy detection operation related to the COT.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings.

These drawings depict only exemplary embodiments of the disclosure and are not therefore to be considered limiting of its scope.

FIG. 1 illustrates a schematic diagram of a wireless communication system in accordance with some embodiments of the present disclosure.

FIGS. 2A and 2B illustrate exemplary LBT based transmissions in a sidelink resource pool in accordance with some embodiments of the present disclosure.

FIGS. 3-5 illustrate flowcharts of exemplary procedures of sidelink communication over an unlicensed spectrum in accordance with some embodiments of the present disclosure.

FIG. 6 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

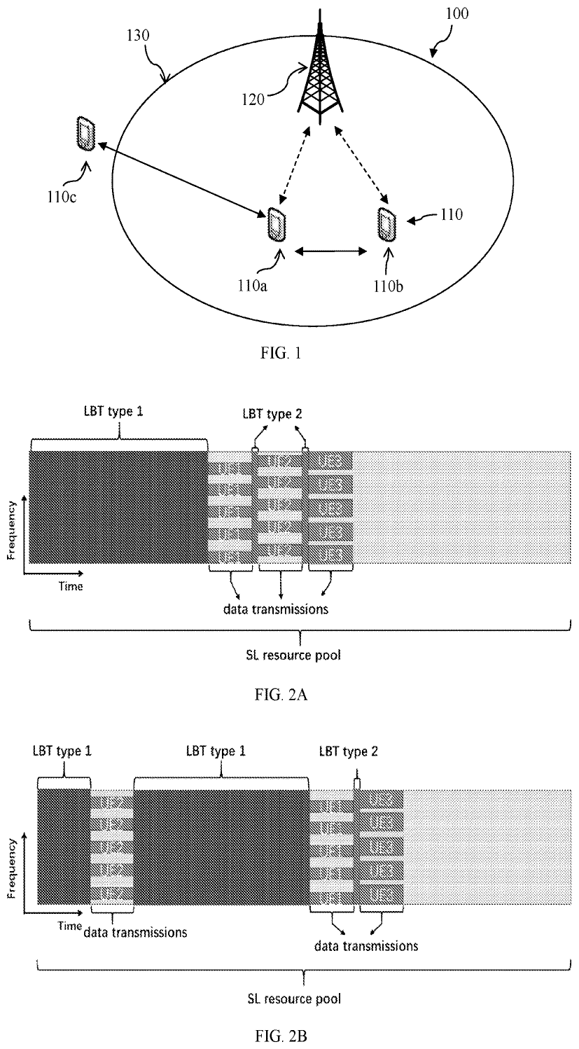

FIG. 1 illustrates a schematic diagram of a wireless communication system 100 in accordance with some embodiments of the present disclosure.

As shown in FIG. 1, a wireless communication system 100 may include a base station (e.g., BS 120) and some UEs 110 (e.g., UE 110a, UE 110b, and UE 110c). Although a specific number of UEs 110 and one BS 120 are depicted in FIG. 1, it is contemplated that any number of BSs and UEs in and outside of the coverage of the BSs may be included in the wireless communication system 100.

In some embodiments of the present disclosure, BS 120 may be referred to as an access point, an access terminal, a base, a base unit, a macro cell, a Node-B, an evolved Node B (eNB), a gNB, a Home Node-B, a relay node, or a device, or described using other terminology used in the art. BS 120 is generally a part of a radio access network that may include one or more controllers communicably coupled to one or more corresponding BSs. BS 120 may communicate with UE(s) 110 via downlink (DL) communication signals.

UE(s) 110 (e.g., UE 110a, UE 110b, or UE 110c) may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, UE(s) 110 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, UE(s) 110 includes wearable devices, such as smart watches, fitness bands, optical head-mounted displays, or the like. Moreover, UE(s) 110 may be referred to as a subscriber unit, a mobile, a mobile station, a user, a terminal, a mobile terminal, a wireless terminal, a fixed terminal, a subscriber station, a user terminal, an IoT device, a vehicle, or a device, or described using other terminology used in the art. UE(s) 110 may communicate with BS 120 via uplink (UL) communication signals.

Wireless communication system 100 may be compatible with any type of network that is capable of sending and receiving wireless communication signals. For example, wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, wireless communication system 100 is compatible with 5G NR of the 3GPP protocol. For example, BS 120 may transmit data using an orthogonal frequency division multiple (OFDM) modulation scheme on the DL and UE(s) 110 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, BS 120 and UE(s) 110 may communicate using other communication protocols, such as the IEEE 802.11 family of wireless communication protocols. Further, in some embodiments of the present disclosure, BS 120 and UE(s) 110 may communicate over licensed spectrums, whereas in some other embodiments, BS 120 and UE(s) 110 may communicate over unlicensed spectrums. The present disclosure is not intended to be limited to the implementation of any particular wireless communication system architecture or protocol.

BS 120 may define one or more cells, and each cell may have a coverage area 130. In the exemplary wireless communication system 100, some UEs (e.g., UE 110a and UE 110b) are within the coverage of BS 120, which may not be the specific BS 120 as shown in FIG. 1 and can be any one of the BSs 120 in a wireless communication system, and some UEs (e.g., UE 110c) are outside of the coverage of BS 120. For example, in the case that the wireless communication system includes two BSs 120 with UE 110a being within the coverage of any one of the two BSs means that UE 110a is within the coverage of a BS 120 (i.e., in-coverage) in the wireless communication system; and UE 110a being outside of the coverage of both BSs 120 means that UE 110a is outside the coverage of a BS 120 (i.e., out-of-coverage) in the wireless communication system.

Still referring to FIG. 1, UE 110a and UE 110b may communicate with BS 120 via, for example, a Uu link (denoted by dotted arrow in FIG. 1). UE 110a, UE 110b, and UE 110c may communicate with each other via a sidelink (denoted by solid arrow in FIG. 1).

Sidelink transmission may involve a physical sidelink control channel (PSCCH) and an associated physical sidelink shared channel (PSSCH), which may be scheduled by the sidelink control information (SCI) carried on the PSCCH. The SCI and associated PSSCH may be transmitted from a transmitting UE (hereinafter referred to as “Tx UE”) to a receiving UE (hereinafter referred to as “Rx UE”) in a unicast manner, to a group of Rx UEs in a groupcast manner, or to Rx UEs within a range in a broadcast manner. For example, referring to FIG. 1, UE 110a (acting as a Tx UE) may transmit data to UE 110b or UE 110c (acting as an Rx UE).

In some embodiments of the present disclosure, sidelink transmission may be performed on an unlicensed spectrum. When an unlicensed spectrum is used for sidelink transmissions, a channel access procedure (also known as a listen-before-talk (LBT) test or LBT procedure) is required before any sidelink transmission. An LBT procedure may be performed based on energy detection in each sensing slot. For example, when the detected energy on a channel in a sensing slot is lower than the energy detection threshold, then the channel is deemed as empty or clear or available in that sensing slot; otherwise, the channel is deemed as occupied or non-available in that sensing slot.

Two types of channel access procedures, i.e., LBT type 1 and LBT type 2 are supported. For LBT type 1 (also known as LBT Cat.4), usually, the energy detection needs to be performed in a range from several sensing slots to hundreds of sensing slots. A random backoff counter may be selected from a contention window (CW) if the initial energy detection fails. The random backoff counter may be decremented by 1 if a sensing slot is deemed as empty. As long as the random backoff counter counts down to zero, the channel can be regarded as available and the transmission can be started. In LBT type 1, the contention window may be continuously updated based on the HARQ-ACK feedback from the receiver. As a result, LBT type 1 may cause an unpredictable sensing time. For LBT type 2 (also known as LBT Cat.2), usually one-shot sensing is performed within, for example, a 16 us sensing interval or within at least 25 us sensing interval. Based on the one-shot sensing, if the channel is deemed as empty then the transmission can get started; otherwise, the transmission fails. As a result, compared to LBT type 1, LBT type 2 is relatively simpler and faster to grab the channel.

For an unlicensed spectrum, by performing LBT type 1, a UE can obtain channel occupancy (CO) and occupy the channel until the maximum channel occupancy time (MCOT). For example, as shown in below Table 1, the MCOT may be related to a channel access priority class (CAPC) value. It should be understood that Table 1 is only for illustrative purposes, and should not be construed as limiting the embodiments of the present disclosure.

TABLE 1
Channel Access Priority Class VS MCOT (T_{ulm cot, p})

| Channel | | | | | |
|---|---|---|---|---|---|
| Access | | | | | |
| Priority | | | | | |
| Class (p) | mₚ | CW_{min, p} | CW_{max, p} | T_{ulmcot, p} | allowed CWₚ sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or | {15, 31, 63, 127, |
| | | | | 10 ms | 255, 511, 1023} |
| 4 | 7 | 15 | 1023 | 6 ms or | {15, 31, 63, 127, |
| | | | | 10 ms | 255, 511, 1023} |

NOTE 1:
For p = 3, 4, T_{ulmcot, p} = 10 ms if the higher layer parameter ‘absenceOfAnyOtherTechnology-r14’ indicates TRUE, otherwise, T_{ulmcot, p} = 6 ms.
NOTE 2:
When T_{ulmcot, p} = 6 ms, it may be increased to 8 ms by inserting one or more gaps. The minimum duration of a gap shall be 100 μs. The maximum duration before including any such gap shall be 6 ms.

According to Table 1, when a UE performs a successful LBT type 1, the UE can occupy the channel at a maximum of 2 ms, 4 ms, 6 ms or 10 ms, depending on the corresponding CAPC value which is determined based on the traffic priority. The higher the CAPC value is, the longer the MCOT on the unlicensed spectrum is. As shown in the above table, for CAPC value of 3 or 4, the MCOT can be 10 ms, which is equivalent to 10 slots in the case of 15 kHz subcarrier spacing, 20 slots in the case of 30 kHz subcarrier spacing, 40 slots in the case of 60 kHz subcarrier spacing, or 80 slots in the case of 120 kHz subcarrier spacing.

Consequently, when a UE (denoted as UE #1 for simplicity) performs a successful LBT type 1 for unicast communication with another ULE (denoted as UE #2 for simplicity), UE #1 can occupy the channel at a maximum of 2 ms, 4 ms, 6 ms or 10 ms. When UE #1 starts the sidelink transmission to UE #2, UE #1 may transmit a PSCCH or a PSSCH in multiple consecutive slots without any transmission gap so as to avoid the risk of losing the channel. From UE #2's point of view, it may not have the information for how many remaining consecutive slots UE #1 will use to transmit sidelink data to it. If UE #2 switches its operating mode from Rx to Tx for transmitting sidelink data/control to other UEs before UE #1 stops transmission, UE #2 may miss the transmissions from UE #1. When UE #2 is requested to transmit a PSFCH(s) corresponding to the received sidelink data, since UE #1 cannot receive the PSFCH feedback from UE #2 corresponding to the missed sidelink transmissions, UE #1 has to perform a new channel access procedure (e.g., LBT type 1) for retransmitting the missed sidelink data. When UE #2 is not requested to send a PSFCH(s) corresponding to the received sidelink data, UE #1 cannot determine whether its transmitted sidelink data is missed by UE #2 or not so that UE #1 may not retransmit the missed sidelink data. As a result, some sidelink data may lose the retransmission opportunity.

FIGS. 2A and 2B illustrate exemplary LBT based transmissions in a sidelink resource pool in accordance with some embodiments of the present disclosure. FIGS. 2A and 2B show two cases of LBT based transmissions in a sidelink resource pool.

In one case as shown in FIG. 2A, based on LBT based transmissions on sidelink (SL) in a SL resource pool, UE1 will perform LBT type 1 to initial a COT for its data transmission(s) on an unlicensed band, if the CAPC level of UE1 is lower than the CAPC level of UE2 and UE3. The COT initiated by UE1 can be shared to UE2 and UE3. In this way, UE2 and UE3 only need to perform LBT type 2 for their data transmissions as shown in FIG. 2A. From a system's perspective, the system latency will be reduced in the case as shown in FIG. 2A.

In a further case as shown in FIG. 2B, if UE2 with a higher CAPC level who performs LBT type 1 to initial a COT, the COT initiated by UE2 cannot be shared to UE1 and UE3 due to the higher CAPC level of UE2. When UE1 performs data transmission(s), UE1 has to perform LBT type 1 again. Then, the COT initiated by UE1 can be shared to UE3. In this way, UE3 only need to perform LBT type 2 for their data transmissions as shown in FIG. 2B. However, from a system's perspective, since both UE2 and UE1 perform LBT type 1, the system latency will be increased in the further case as shown in FIG. 2B.

Accordingly, when an unlicensed spectrum is used for sidelink transmission, an issue of how to reduce time of a LBT procedure from a system's perspective needs to be addressed. Embodiments of the present disclosure provide solutions to solve the above issue. For example, some embodiments of the present disclosure configure a single CAPC value per a resource pool for LBT type 1. Some embodiments of the present disclosure determine a CAPC value based on the configured or preconfigured priority level for a resource pool. Some embodiments of the present disclosure determine an energy detection threshold based on the configured or preconfigured COT sharing energy detection threshold for a resource pool. More details on the embodiments of the present disclosure will be illustrated in the following text in combination with the appended drawings.

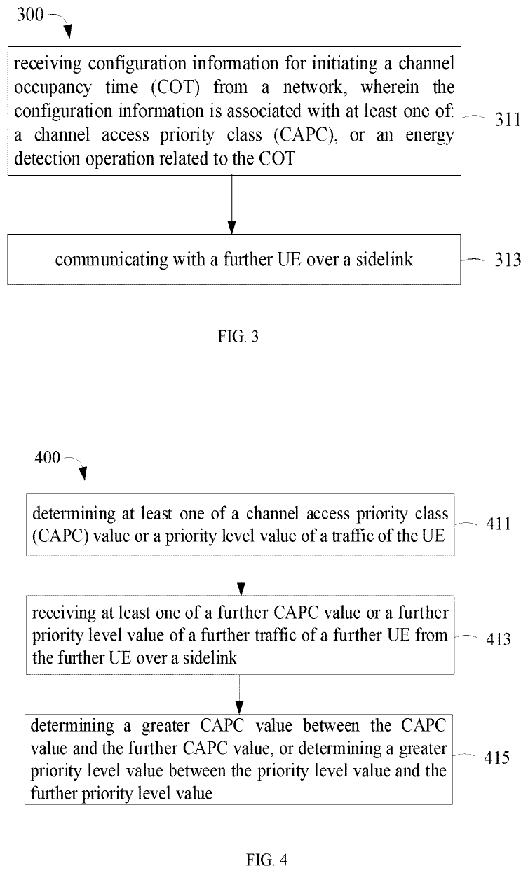

FIG. 3 illustrates a flow chart of exemplary procedure 300 for sidelink communication over an unlicensed spectrum in accordance with some embodiments of the present disclosure. Details described in all of the foregoing embodiments of the present disclosure are applicable for the embodiments shown in FIG. 3. In some examples, the procedure may be performed by a UE, for example, UE 110 in FIG. 1.

Referring to FIG. 3, in operation 311, a UE (e.g., UE 110a in FIG. 1 or UE1 in FIGS. 2A and 2B) may receive configuration information for initiating a COT from a network (e.g., BS 120 in FIG. 1). The configuration information may be associated with at least one of a CAPC or an energy detection operation related to the COT. In operation 313, the UE may communicate with a further UE (e.g., UE 110b in FIG. 1, UE2 in FIG. 2A, or UE3 in FIGS. 2A and 2B) over a sidelink.

In some embodiments, the configuration information may be configured or preconfigured to the UE.

In some embodiments, in response to the configuration information being associated with the CAPC, the configuration information includes at least one of:
(1) A CAPC value (denoted as “1st CAPC value” for simplicity) for a resource pool on an unlicensed band.
(2) A mapping relationship between one or more traffic priority level values and one or more CAPC values.
(3) A priority level value for the resource pool on the unlicensed band.
(4) A mapping relationship between the priority level value and one CAPC value.

In some embodiments, the UE (e.g., UE1 in FIG. 2A) determines the 1st CAPC value based on the configuration information, and performs a channel access procedure (e.g., LBT type 1) for initiating the COT based on one or more parameters related to the 1st CAPC value. Then, the UE may receive data from the further UE (e.g., UE2 or UE3 in FIG. 2A) over the sidelink using the COT initiated by the UE.

In an embodiment, a CAPC value per a resource pool is configured for LBT type 1. For instance, a network configures or preconfigures a CAPC index indication for a sidelink resource pool on an unlicensed band. When the UE (e.g., UE1 in FIG. 2A) performs LBT type 1 for channel access, the UE may determine parameters my, CW_{min,p}, CW_{max,p}, and T_{ulmcot,p} based on the configured or preconfigured CAPC p as shown in above Table 1. For example, the network configures or preconfigures the index indication of CAPC p to “4” as shown in Table 1, and then the UE may determine that mₚ=7, CW_{min,p}=15, CW_{max,p}=1023, and T_{ulmcot,p}=6 ms or 10 ms, as shown in the last row of Table 1.

In some embodiments, the UE (e.g., UE1 in FIG. 2A) determines a traffic priority level value of the UE, and determines a further CAPC value (denoted as “2nd CAPC value” for simplicity) corresponding to the traffic priority level value based on the mapping relationship between one or more traffic priority level values and one or more CAPC values. In some embodiments, the UE determines the 1st CAPC value based on the configuration information, determines a greater CAPC value between the 1st CAPC value and the 2nd CAPC value, and performs a channel access procedure (e.g., LBT type 1) for initiating the COT based on one or more parameters related to the greater CAPC value. Then, the UE may receive data from the further UE (e.g., UE2 or UE3 in FIG. 2A) over the sidelink using the COT initiated by the UE.

In an embodiment, when the UE (e.g., UE1 in FIG. 2A) performs LBT type 1 for channel access, the UE may determine mₚ, CW_{min,p}, and CW_{max,p} based on configured or preconfigured CAPC p and its traffic priority level associated CAPC p. If its traffic priority level associated CAPC p is greater than the configured or preconfigured CAPC p, its traffic priority level associated CAPC p is used; otherwise, the configured or preconfigured CAPC p is used.

For instance, as shown in below Table 2, a traffic priority level may be related to a CAPC value. It should be understood that Table 2 is only for illustrative purposes, and should not be construed as limiting the embodiments of the present disclosure. In Table 2, a lower traffic priority level value means a higher priority level, and a greater traffic priority level value means a lower priority level, a lower CAPC value means a higher CAPC level with shorter COT time, and a greater CAPC value means a lower CAPC level with longer COT time.

TABLE 2
Mapping relationship between priority level and CAPC

| Priority Level | CAPC |
|---|---|
| 0 | 1 |
| 1 | 1 |
| 2 | 2 |
| 3 | 2 |
| 4 | 3 |
| 5 | 3 |
| 6 | 4 |
| 7 | 4 |

As shown in Table 2, if the traffic priority level value is 0 or 1, the associated CAPC value is 1. If the traffic priority level value is 2 or 3, the associated CAPC value is 2. If the traffic priority level value is 4 or 5, the associated CAPC value is 3. If the traffic priority level value is 6 or 7, the associated CAPC value is 4. For example, if a CAPC value configured or preconfigured for a resource pool is 2, and if the CAPC value associated with a traffic priority level value is 3 as shown in Table 2 (e.g., the traffic priority level value is 4 or 5), the UE determines that the associated CAPC value 3 is a greater value (which means a lower CAPC level with longer COT time), and then CAPC value 3 is used. If the CAPC value configured or preconfigured for a resource pool is 4, and the associated CAPC level is 3 (e.g., the traffic priority level value is 4 or 5), the UE determines that the configured or preconfigured CAPC value 4 is a greater value (which means a lower CAPC level with longer COT time), and then CAPC value 4 is used.

Referring back to FIG. 3, in some embodiments, the UE (e.g., UE1 in FIG. 2A) determines the priority level value based on the configuration information, and determines a traffic priority level value of the UE. The UE transmits the traffic of the UE to the further UE (e.g., UE2 or UE3 in FIG. 2A) over the sidelink, in response to the traffic priority level value being less than or equal to the priority level value. The UE does not transmit the traffic of the UE to the further UE, in response to the traffic priority level value being greater than the priority level value. In some embodiments, to transmit the traffic of the UE, the UE may determine the one CAPC value based on the mapping relationship between the priority level value and one CAPC value, and perform a channel access procedure (e.g., LBT type 1) for initiating the COT based on one or more parameters related to the one CAPC value. Then, the UE may receive data from the further UE over the sidelink using the COT initiated by the UE.

In an embodiment, the UE (e.g., UE1 in FIG. 2A) determines a CAPC value based on a priority level value configured or preconfigured for a resource pool. For instance, a network configures or preconfigures a priority level for a sidelink resource pool on unlicensed band. If the traffic priory level of the UE is greater than or equal to the configured or preconfigured priority level, this traffic of the UE can be transmitted in this resource pool. Based on the mapping relationship traffic priority level and CAPC, e.g., as shown in Table 2, this configured or preconfigured priority level can be mapped to a CAPC level. When the UE performs LBT type 1 for channel access, the UE may determine mₚ, CW_{min,p}, and CW_{max,p} based on the mapped CAPC level as shown in Table 2.

For example, a priority level value 5 is configured or preconfigured as a priority threshold for a resource pool on an unlicensed band. The UE's traffic with a priority level higher than or equal to 5 can be transmitted in this resource pool. That is, the traffic with a priority level value 0, 1, 2, 3, 4, or 5 (which represents higher priority level than the configured or preconfigured priority level) can be transmitted. Likewise, for example, a priority level value 3 is configured or preconfigured for the resource pool, the traffic with a priority level value “0, 1, 2, or 3” (which represents higher priority level than the configured or preconfigured priority level) can be transmitted in this resource pool.

With reference to Table 2, the UE (e.g., UE1 in FIG. 2A) may determine that the CAPC value corresponding to the configured or preconfigured priority level 5 is 3. A CAPC value corresponding to the traffic priority level value “0, 1, 2, 3, 4, or 5” is “1, 2, or 3”, respectively. In this embodiment, all traffic with a priority level value 0, 1, 2, 3, 4, or 5 needs to be transmitted in this resource pool based on the CAPC value 3 (i.e., the determined one CAPC value describe above) which corresponds to the configured or preconfigured priority level 5. That is, the UE may perform a channel access procedure (e.g., LBT type 1) for initiating COT based on parameter(s), e.g., mₚ, CW_{min,p}, and CW_{max,p}, related to the CAPC value 3 as shown in Table 1, and the COT can be shared by the UE to the further UE (e.g., UE2 or UE3 in FIG. 2A).

Referring again back to FIG. 3, in some embodiments, in response to the configuration information being associated with the energy detection operation, the configuration information includes an energy detection threshold (denoted as “1st energy detection threshold” for simplicity) for a resource pool on an unlicensed band. In an embodiment, the UE (e.g., UE2 or UE3 in FIG. 2A) may set an energy detection threshold (denoted as “2nd energy detection threshold” for simplicity) to be equal to or less than the 1st energy detection threshold, and perform a LBT type 2 procedure based on the 2nd energy detection threshold, and use the COT initiated by the further UE during communicating with the further UE.

In a further embodiment, the UE (e.g., UE1 in FIG. 2A) may set the 2nd energy detection threshold to be equal to or less than the 1st energy detection threshold, and perform a channel access procedure (e.g., LBT type 1) for initiating the COT based on the 2nd energy detection threshold. Then, the UE may receive data from the further UE over the sidelink using the COT initiated by the UE.

It should be appreciated by persons skilled in the art that the sequence of the operations in exemplary procedure 300 may be changed and some of the operations in exemplary procedure 300 may be eliminated or modified, without departing from the spirit and scope of the disclosure.

FIG. 4 illustrates a flow chart of an exemplary procedure 400 for wireless communications in accordance with some embodiments of the present disclosure. Details described in all of the foregoing embodiments of the present disclosure are applicable for the embodiments shown in FIG. 4. In some examples, the procedure may be performed by a LIE, for example, LIE 110 in FIG. 1.

Referring to FIG. 4, in operation 411, a LIE (e.g., LIE 110a in FIG. or UE1 in FIGS. 2A and 2B 1) may determine at least one of a CAPC value (denoted as “1st CAPC value” for simplicity) or a priority level value (denoted as “1st priority level value” for simplicity) of a traffic of the UE. In operation 413, the UE may receive at least one of a further CAPC value (denoted as “2nd CAPC value” for simplicity) or a further priority level value (denoted as “2nd priority level value” for simplicity) of a further traffic of a further UE (e.g., UE 110b in FIG. 1, UE2 in FIG. 2A, or UE3 in FIGS. 2A and 2B) from the further UE over a sidelink. In operation 415, the UE may determine a greater CAPC value between the 1st CAPC value and the 2nd CAPC value, or determine a greater priority level value between the 1st priority level value and the 2nd priority level value.

In some embodiments, the UE (e.g., UE1 in FIG. 2A) transmits at least one of the greater CAPC value or the greater priority level value to the further UE (e.g., UE2 or UE3 in FIG. 2A) over the sidelink.

In some embodiments, the UE (e.g., UE1 in FIG. 2A) performs a channel access procedure for initiating a COT based on at least one of the greater CAPC value or the greater priority level value. The channel access procedure may be a LBT type 1 procedure. In an embodiment, the UE receives data from the further UE (e.g., UE2 or UE3 in FIG. 2A) over the sidelink using the COT initiated by the UE.

In some embodiments, the UE (e.g., UE1 in FIG. 2A) transmits an energy detection threshold of the UE to the further UE (e.g., UE2 or UE3 in FIG. 2A) over the sidelink. LBT type 2 procedure may be performed by the further UE based on the energy detection threshold.

In an embodiment, an energy detection threshold of the UE (e.g., UE1 in FIG. 2A) may be determined based on an energy detection threshold configured or preconfigured for a sidelink resource pool, e.g., COTsharingEnergyDetectionThreshold. For instance, a network configures or preconfigures a COTsharingEnergyDetectionThreshold for a sidelink resource pool on an unlicensed band. If the UE performs LBT type 1 and tries to share its initiated COT to the further UE (e.g., UE2 or UE3 in FIG. 2A), the UE should set its energy detection threshold to be equal to or less than the configured or preconfigured COTsharingEnergyDetectionThreshold. The UE may also be named as a COT initial UE or the like. The UE sets the energy detection threshold for LBT type 1 and COT sharing to be equal to or less than the value provided by the higher layer parameter COTsharingEnergyDetectionThreshold. The further UE who is shared the COT initiated by the COT initial UE needs to set its energy detection threshold to be equal to or less than COTsharingEnergyDetectionThreshold, when it performs LBT type 2.

In an embodiment, the UE (e.g., UE1 in FIG. 2A) determines its CAPC value based on a maximum CAPC value or a maximum priority level value among others UE(s) in the resource pool. For example, if other UEs include UE A, UE B, UE C, and so on (e.g., UE2 or UE3 in FIG. 2A), the UE may determine its CAPC value as maximum {the UE's CAPC value, UE A's CAPC value, UE B's CAPC value, UE C's CAPC value . . . }. Or, the UE may determine its CAPC value as maximum {the UE's priority level value, UE A's priority level value, UE B's priority level value, UE C's priority level value . . . }. In this embodiment, the UE is a reception UE of UE A, UE B, UE C, and so on. For instance, others UEs may determine that a destination ID is of the UE, e.g., in a unicast transmission or groupcast option 2 (groupcast transmission with a feedback of ACK or NACK). Or, others UEs perform a broadcast transmission or a groupcast option 1 (groupcast transmission with a feedback of only NACK), and thus the UE is a reception UE. The UE may transmit the determined CAPC value or the determined priority level value to any of other UE(s) over the sidelink.

Behaviors of others UE(s) (e.g., UE2 or UE3 in FIG. 2A) who is shared the COT initiated by the COT initial UE are as follows. For instance, UE2 may determine whether UE1 is a destination UE of UE2, and if UE1 is the destination UE of UE2, UE2 can be shared the COT initialed by UE1 (i.e., UE2 can transmit data within the COT initialed by UE1). UE2 may perform a broadcast transmission or groupcast option 1, and thus UE1 is a reception UE, and UE2 can be shared the COT initialed by UE1.

It should be appreciated by persons skilled in the art that the sequence of the operations in exemplary procedure 400 may be changed and some of the operations in exemplary procedure 400 may be eliminated or modified, without departing from the spirit and scope of the disclosure.

FIG. 5 illustrates a flow chart of an exemplary procedure 500 for wireless communications in accordance with some embodiments of the present disclosure. Details described in all of the foregoing embodiments of the present disclosure are applicable for the embodiments shown in FIG. 5. In some examples, the procedure may be performed by a UE, for example, UE 110 in FIG. 1.

Referring to FIG. 5, in operation 511, a UE (e.g., UE 110b in FIG. 1, UE2 in FIG. 2A, or UE3 in FIGS. 2A and 2B) may transmit at least one of a CAPC value (denoted as “1st CAPC value” for simplicity) or a priority level value (denoted as “1st priority level value” for simplicity) of a traffic of the UE to a further UE (e.g., UE 110a in FIG. 1 or UE1 in FIGS. 2A and 2B) over a sidelink.

In operation 513, the UE (e.g., UE2 or UE3 in FIG. 2A) may receive at least one of a greater CAPC value or a greater priority level value from the further UE (e.g., UE1 in FIG. 2A) over the sidelink. The greater CAPC value is determined by the further UE between the 1st CAPC value and a further CAPC value (denoted as “2nd CAPC value” for simplicity) of a further traffic of the further UE. The greater priority level value is determined by the further UE between the 1st priority level value and a further priority level value (denoted as “2nd priority level value” for simplicity) of the further traffic of the further UE.

In some embodiments, the UE (e.g., UE2 or UE3 in FIG. 2A) receives an energy detection threshold from the further UE (e.g., UE1 in FIG. 2A) over the sidelink, and performs a LBT type 2 procedure based on the energy detection threshold.

In some embodiments, the UE (e.g., UE2 or UE3 in FIG. 2A) determines whether the further UE (e.g., UE1 in FIG. 2A) is a destination UE of the UE. In response to determining that the further UE is a destination UE of the UE, the UE uses a COT initiated by the further UE. The UE may transmit data to the further UE over the sidelink using the COT initiated by the further UE.

In some embodiments, the UE (e.g., UE2 or UE3 in FIG. 2A) determines whether the UE will perform a broadcast transmission or a groupcast transmission with a feedback of only NACK. In response to determining that the UE will perform the broadcast transmission or the groupcast transmission with the feedback of only NACK, the UE uses a COT initiated by the further UE (e.g., UE1 in FIG. 2A). The UE may transmit data to the further UE over the sidelink using the COT initiated by the further UE.

It should be appreciated by persons skilled in the art that the sequence of the operations in exemplary procedure 500 may be changed and some of the operations in exemplary procedure 500 may be eliminated or modified, without departing from the spirit and scope of the disclosure.

In addition, some embodiments of the present application provide an exemplary flowchart of a network node (e.g., a BS) transmitting configuration information for initiating a COT in accordance with some embodiments of the present application. Although described with respect to a network node, it should be understood that other devices may be configured to perform a similar method.

It should be appreciated by persons skilled in the art that the sequence of the operations in this exemplary flowchart of a network node may be changed and some of the operations in this exemplary flowchart may be eliminated or modified, without departing from the spirit and scope of the disclosure. Details described in all other embodiments of the present application, e.g., in the embodiments of FIGS. 2-5 are applicable for this exemplary flowchart. Moreover, details described in this exemplary flowchart are applicable for all the embodiments of FIGS. 1-6.

In particular, in this exemplary flowchart, a BS (e.g., BS 120 in FIG. 1) transmits configuration information for initiating a COT to a UE (e.g., UE 110, UE1, UE2, or UE3 in FIGS. 1, 2A, and 2B). The configuration information may be associated with at least one of a CAPC or an energy detection operation related to the COT.

In some embodiments, the configuration information is configured or preconfigured to the UE.

In some embodiments, in response to the configuration information being associated with the CAPC, the configuration information includes at least one of:
(1) A CAPC value for a resource pool on an unlicensed band. For instance, the BS configures or preconfigures a CAPC index indication for a sidelink resource pool on an unlicensed band.
(2) A mapping relationship between one or more traffic priority level values and one or more CAPC values, e.g., “Mapping relationship between priority level and CAPC” as shown in above Table 2.
(3) A priority level value for the resource pool on the unlicensed band. For instance, the BS configures or preconfigures a priority level for a sidelink resource pool on unlicensed band.
(4) A mapping relationship between the priority level value and one CAPC value, e.g., “Mapping relationship between priority level and CAPC” as shown in above Table 2.

In some embodiments, in response to the configuration information being associated with the energy detection operation, the configuration information includes an energy detection threshold (e.g., COTsharingEnergyDetectionThreshold) for a resource pool on an unlicensed band. A UE (e.g., UE1 in FIGS. 2A and 2B) sets its energy detection threshold to be equal to or less than the value provided by the higher layer parameter COTsharingEnergyDetectionThreshold when performing LBT type 1 and sharing COT. A further UE (e.g., UE3 in FIGS. 2A and 2B) who is shared the COT initiated by the UE set its energy detection threshold to be equal to or less than COTsharingEnergyDetectionThreshold when performing LBT type 2.

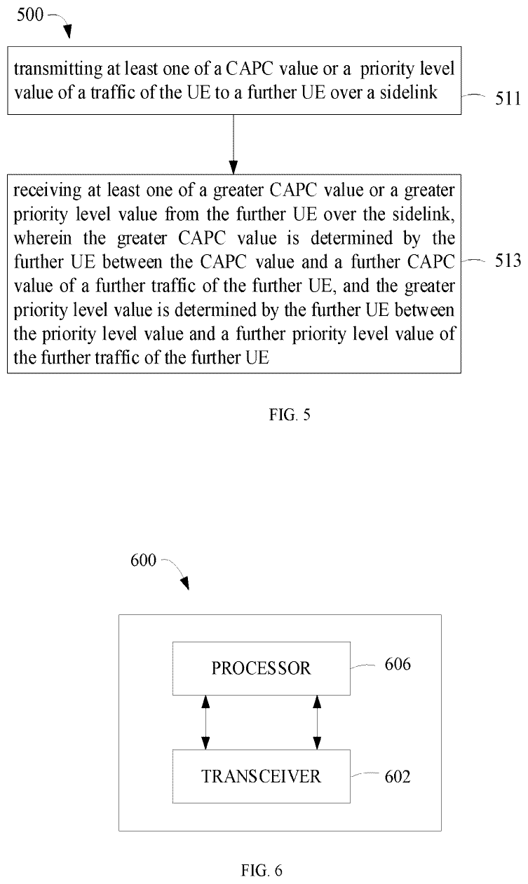

FIG. 6 illustrates a block diagram of an exemplary apparatus 600 in accordance with some embodiments of the present disclosure. As shown in FIG. 6, the apparatus 600 may include at least one processor 606 and at least one transceiver 602 coupled to the processor 606. The apparatus 600 may be a UE or a BS.

Although in this figure, elements such as the at least one transceiver 602 and processor 606 are described in the singular, the plural is contemplated unless a limitation to the singular is explicitly stated. In some embodiments of the present application, the transceiver 602 may be divided into two devices, such as a receiving circuitry and a transmitting circuitry. In some embodiments of the present application, the apparatus 600 may further include an input device, a memory, and/or other components.

In some embodiments of the present application, the apparatus 600 may be a UE. The transceiver 602 and the processor 606 may interact with each other so as to perform the operations with respect to the UEs described above, for example, in FIGS. 1-5.

In some embodiments of the present application, the apparatus 600 may be a BS. The transceiver 602 and the processor 606 may interact with each other so as to perform the operations with respect to the BSs described above, for example, in FIGS. 1-4.

In some embodiments of the present application, the apparatus 600 may further include at least one non-transitory computer-readable medium. For example, in some embodiments of the present disclosure, the non-transitory computer-readable medium may have stored thereon computer-executable instructions to cause the processor 606 to implement the method with respect to the UEs as described above. For example, the computer-executable instructions, when executed, cause the processor 606 interacting with transceiver 602 to perform the operations with respect to the UEs described in FIGS. 1-5.

For example, in some embodiments of the present disclosure, the non-transitory computer-readable medium may have stored thereon computer-executable instructions to cause the processor 606 to implement the method with respect to the BSs as described above. For example, the computer-executable instructions, when executed, cause the processor 606 interacting with transceiver 602 to perform the operations with respect to the BSs described in FIGS. 1-5.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE) for wireless communication, comprising:
at least one memory; and
at least one processor coupled with the at least one memory and configured to cause the UE to:
receive, from a network node, configuration information for initiating a channel occupancy time (COT), the configuration information associated with at least one of channel access priority class (CAPC), or an energy detection operation related to the COT; and
communicate with a second UE over a sidelink.

2. The UE of claim 1, wherein the configuration information is configured or preconfigured to the UE.

3. The UE of claim 1, wherein, based at least in part on the configuration information being associated with the CAPC, the configuration information includes at least one of:
a first CAPC value for a resource pool on an unlicensed band;
a first mapping relationship between one or more traffic priority level values and one or more CAPC values;
a priority level value for the resource pool on the unlicensed band; or
a second mapping relationship between the priority level value and one CAPC value.

4. The UE of claim 3, wherein the at least one processor is configured to cause the UE to:
determine the first CAPC value based on the configuration information; and
perform a channel access procedure for initiating the COT based on one or more parameters related to the first CAPC value.

5. The UE of claim 3, wherein the at least one processor is configured to cause the UE to:
determine a traffic priority level value of the UE; and
determine a second CAPC value corresponding to the traffic priority level value based on the first mapping relationship.

6. The UE of claim 5, wherein the at least one processor is configured to cause the UE to:
determine the first CAPC value based on the configuration information;
determine a greater CAPC value between the first CAPC value and the second CAPC value; and
perform a channel access procedure for initiating the COT based on one or more parameters related to the greater CAPC value.

7. The UE of claim 3, wherein the at least one processor is configured to cause the UE to:
determine the priority level value based on the configuration information;
determine a traffic priority level value of the UE; and
transmit, to the second UE over the sidelink, data traffic of the UE based at least in part on the traffic priority level value being less than or equal to the priority level value; or
not transmit the data traffic of the UE to the second UE, based at least in part on the traffic priority level value being greater than the priority level value.

8. The UE of claim 1, wherein, in response to the configuration information being associated with the energy detection operation, the configuration information includes a first energy detection threshold for a resource pool on an unlicensed band.

9. The UE of claim 8, wherein the at least one processor is configured to cause the UE to set a second energy detection threshold to be equal to or less than the first energy detection threshold.

10. The UE of claim 9, wherein the at least one processor is configured to cause the UE to:
perform a listen-before-talk (LBT) type 2 procedure based on the second energy detection threshold; and
use the COT initiated by the second UE during communicating with the second UE.

11. A user equipment (UE) for wireless communication, comprising:
at least one memory; and
at least one processor coupled with the at least one memory and configured to cause the UE to:
determine at least one of a first channel access priority class (CAPC) value or a first priority level value of a first data traffic of the UE;
receive, from a second UE over sidelink, at least one of a second CAPC value or a second priority level value of a second data traffic of the second UE; and
determine a greater CAPC value between the first CAPC value and the second CAPC value, or determine a greater priority level value between the first priority level value and the second priority level value.

12. A network node for wireless communication, comprising:
at least one memory; and
at least one processor coupled with the at least one memory and configured to cause the network node to transmit, to a user equipment (UE), configuration information for initiating a channel occupancy time (COT), the configuration information associated with at least one of a channel access priority class (CAPC), or an energy detection operation related to the COT.

13. The network node of claim 12, wherein the configuration information is configured or preconfigured to the UE.

14. The network node of claim 12, wherein, based at least in part on the configuration information being associated with the CAPC, the configuration information includes at least one of:
a CAPC value for a resource pool on an unlicensed band;
a first mapping relationship between one or more traffic priority level values and one or more CAPC values;
a priority level value for the resource pool on the unlicensed band; or
a second mapping relationship between the priority level value and one CAPC value.

15. The network node of claim 12, wherein, in response to the configuration information being associated with the energy detection operation, the configuration information includes an energy detection threshold for a resource pool on an unlicensed band.

16. A processor for wireless communication, comprising:
at least one controller coupled with at least one memory and configured to cause the processor to:
receive configuration information for initiating a channel occupancy time (COT), the configuration information associated with at least one of a channel access priority class (CAPC), or an energy detection operation related to the COT; and
communicate with a user equipment (UE) over a sidelink.

17. The processor of claim 16, wherein the configuration information is configured or preconfigured.

18. The processor of claim 16, wherein, based at least in part on the configuration information being associated with the CAPC, the configuration information includes at least one of:
a first CAPC value for a resource pool on an unlicensed band;
a first mapping relationship between one or more traffic priority level values and one or more CAPC values;
a priority level value for the resource pool on the unlicensed band; or
a second mapping relationship between the priority level value and one CAPC value.

19. The processor of claim 18, wherein the at least one controller is configured to cause the processor to:
determine the first CAPC value based on the configuration information; and
perform a channel access procedure for initiating the COT based on one or more parameters related to the first CAPC value.

20. The processor of claim 18, wherein the at least one controller is configured to cause the processor to:
determine a traffic priority level value of the UE; and
determine a second CAPC value corresponding to the traffic priority level value based on the first mapping relationship.
